(19) United States
(12) Patent Application Publication
(10) Pub. No.: US 2006/0240290 A1
(43) Pub. Date: Oct. 26, 2006

(54) High rate pulsed battery

(76) Inventors: Richard K. Holman, Belmont, MA (US); Andrew L. Loxley, Roslindale, MA (US)

Correspondence Address: WILMER CUTLER PICKERING HALE AND DORR LLP, 60 STATE STREET, BOSTON, MA, 02109, US

(21) Appl. No.: 11/111,102

(22) Filed: Apr. 20, 2005

(51) Int. Cl. H01M 14/00; H01M 4/58; H01M 4/52

(52) U.S. Cl. 429/3; 429/231.95; 429/128; 429/231.3; 429/231.4

(57) ABSTRACT

A lithium secondary cell includes a plurality of stacked layers. The stacked layer includes a lithium-containing positive electrode in electronic contact with a positive electrode current collector, the positive current collector in electrical connection with an external circuit, wherein the positive electrode has a total volumetric energy density of greater than of at least about 1460 Wh/L versus lithium at C/5 rate, a total areal capacity of greater than about 7.5 mA-h/cm² and a total thickness of at least about 200 μm, a negative electrode in electronic contact with a negative electrode current collector, the negative current collector in electrical connection with an external circuit, a separator positioned between the cathode and the anode, the separator having a porosity of at least about 45 vol % and a thickness of less than about 50 μm, and an electrolyte in ionic contact with the positive and negative electrodes. The cell may be used to drive an electronic device that is operatable using a pulsed current protocol.

### BACKGROUND

1. Field of the Invention

This invention relates to a non-aqueous electrolyte secondary cell having an extended run time. In particular, the invention relates to a battery for use in pulsed current applications.

2. Background of the Invention

Contemporary portable electronic appliances rely almost exclusively on rechargeable Li-ion batteries as the source of power. This has spurred a continuing effort to increase their energy storage capability, power capabilities, cycle life and safety characteristics and decrease their cost. Lithium-ion battery or lithium ion cell refers to a rechargeable battery having an anode capable of storing a substantial amount of lithium at a lithium chemical potential above that of lithium metal.

Presently, a lithium ion secondary battery has been commercialized as a nonaqueous electrolyte secondary battery for use in wireless communication devices, such as a portable telephone. The lithium ion secondary battery includes a positive electrode containing lithium cobalt oxide (LCO), a negative electrode containing a graphitized material or a carbonaceous material, a nonaqueous electrolyte prepared by dissolving a lithium salt in an organic solvent, and a separator formed substantially of a porous film. A nonaqueous solvent having a low viscosity is used as the solvent for preparing the nonaqueous electrolyte.

Typical practice in the lithium ion battery field is to use electrodes having a single layer thickness of 70 to 90 μm, a single layer loading or capacity per unit area of 2.5 to 3.5 mAh/cm² (calendared to density of 2.4-3.8 g/cm³ for the positive electrode based on LCO or 1.5-1.7 g/cm³ for the negative electrode based on graphite), and a microporous polyolefin separator having a thickness of 15 to 25 μm and a porosity of 35 to 45%. This leads typically to stack energy densities of 400 to 600 Wh/L and cell energy densities of 300 to 450 Wh/L.

For wound cells, the electrodes must also be capable of being wound to certain radii of curvature, which limits the thickness and density of the electrodes. For stacked cells, thicker electrodes have been avoided because of their reduced rate capability. Furthermore, safety concerns with high energy density cells, evidenced by numerous safety-related recalls of cell phone and laptop batteries, has taught away from the development of higher energy density cells based on LiCoO₂. See, http://www.cbsnews.com/stories/2004/10/28/tech/main652128.shtml (Exploding Cell Phones Spur Recalls). The slow adoption of the higher energy 2.4 Ah 18650 cylindrical cells (‘18’ denotes the diameter in millimeters and ‘650’ describes a cell length of 65 millimeters) reflects the industry's concern with safety at higher energy density.

For wireless communications applications, a variety of pulse protocols are used. In order to be commercially practical, batteries must be capable of operating under these pulsed protocols. For example, using the Global System for Mobile communication (GSM) protocol, the battery is required to deliver a 550 μs current pulse of up to around 2 A every 4.6 ms. During the 4.05 ms “pulse-off” period there is a continuous current draw of 100 mA. The pulse frequency is fixed, but the amplitude depends on the distance between the user and the communications tower (the farther from the tower, the higher the pulse current required). Using the Code-Division Multiple Access (CDMA) protocol, the pulse duration is 1.25 ms and both the frequency and amplitude depend on usage; more talking requires higher frequency current pulsing, and the distance of the user from the tower determines the pulse amplitude. The “pulse-off” current draw also is around 100 mA. When transmitting data continuously by CDMA, the current draw is in effect a continuous draw and the amplitude is dependant on the distance from the communications tower. The maximum current draw in this case is around 700 mA. The Integrated Dispatch Enhanced Network (IDEN) protocol is another variation where there are three instead of two current levels.

Practical Li-ion batteries used in consumer products such as cellular telephones and notebook computers are discharged at C/5 to 2 C rates and they are capable of 500-1000 full depth charge/discharge cycles. There is an ongoing effort to improve the specific energy, energy density and specific power (current drain rate) of Li-ion batteries.

### SUMMARY OF THE INVENTION

Higher energy density cells have been viewed by those skilled in the art as being less, not more, safe. The inventors have surprisingly and counter-intuitively discovered a lithium ion secondary battery incorporating the features of a high energy, low rate electrode and a porous, high rate separator that provides higher energy, yet greater safety.

A thicker electrode, while theoretically providing high energy density, is typically a low rate electrode, and therefore not considered practical. Furthermore, a high porosity (high rate) separator has been viewed as unnecessary for low and constant discharge rate applications since the impedance represented by the separator under such conditions is but a small fraction of the total cell impedance. Thus, the combination of a low rate electrode and a high porosity (high rate) separator has heretofore been considered undesirable or unnecessary.

According to one aspect of the invention, a lithium ion secondary battery includes a plurality of stacked layers. As used herein “stacked layers” refers to individual electrodes stacked one upon another to create multiple individual cells, each cell having a positive electrode, a separator and a negative electrode.

In one aspect of the invention, a lithium secondary cells includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total volumetric energy density of at least about 1460 Wh/L versus lithium at C/5 rate. Also in this aspect, the negative current collector is in electrical connection with an external circuit. The separator has a porosity of at least about 45 vol % and a thickness of less than about 50 μm. In one embodiment, a portable electronic device operable according to a pulsed current protocol includes a wireless communication device and the lithium secondary battery of this aspect of the invention, which provides power to the wireless device and the power is delivered as a pulsed current.

In another aspect of the invention, a lithium secondary cell includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. The cell has a stacked energy density of at least about 600 Wh/L at C/5. In this aspect, the positive current collector is in electrical connection with an external circuit. The positive electrode has a total volumetric energy density of at least about 1460 Wh/L versus lithium at C/5 rate. Also in this embodiment, the negative current collector is in electrical connection with an external circuit. The negative electrode has a total volumetric specific capacity including current collector foil of at least of at least about 460 Ah/L. The separator has a porosity of at least about 45 vol % and a thickness of less than about 50 μm.

In another aspect, the invention includes a method of operating a lithium secondary battery. The method includes providing a lithium secondary battery and delivering a current pulse of at least about 700 mA for a duration of at least about 500 μsec with polarization of less than about 100 mV from the battery through the external circuit. The secondary battery includes a plurality of stacked layers that include a lithium-containing positive electrode in electronic contact with a positive electrode current collector, a negative electrode in electronic contact with a negative electrode current collector, a separator positioned between the positive electrode and the negative electrode, and an electrolyte in ionic contact with the positive and negative electrodes. In this aspect, the positive current collector is in electrical connection with an external circuit. The positive electrode has a total volumetric energy density of at least about 1460 Wh/L versus lithium at C/5 rate. Also in this aspect, the negative current collector is in electrical connection with an external circuit. The separator has a porosity of at least about 45 vol % and a thickness of less than about 50 μm.

In some embodiments, the stacked layer includes a lithium-containing positive electrode in electronic contact with a positive electrode current collector. The positive current collector is in electrical connection with an external circuit. The positive electrode further has a total areal capacity of greater than about 7.7 mA-h/cm², a total volumetric energy density of at least about 1460 Wh/L versus lithium at C/5 rate, a thickness of at least about 95 μm for a single sided coated electrode excluding the current collector and a total thickness of at least about 200 μm for a double sided coated electrode including the current collector. The negative electrode is in electronic contact with a negative electrode current collector, and the negative current collector is in electrical connection with an external circuit. The separator is positioned between the negative and positive electrode and has a porosity of at least about 45 vol % and a thickness of less than about 50 μm. An electrolyte is in contact with the separator and is in ionic contact with the positive and negative electrodes. The electrolyte has a conductivity of about 5-15×10⁻³ S and an electrolyte salt at a concentration in the range of about 0.5M to about 1.5 M.

As used herein ‘electrode thickness’ refers to the thickness of a single layer of electrode excluding the current collector, and ‘total thickness’ refers to the thickness of the double layer electrode including the current collector. Areal capacity and total volumetric energy density are reported for the thickness of the double layer electrode including the current collector.

In one embodiment, a lithium secondary cell is provided having a positive electrode with a total thickness of about 230 microns, a total active material loading of about 70 mg/cm², and a capacity per unit area of about 9.5 mAh/cm². The cell further includes a separator having a porosity of about 52% and thickness of about 20 μm. The cell is a stacked cell construction which permits thicker electrode layers and provides more efficient packing of a form factor, e.g., a prismatic form factor. The cell provides about 40% longer run time than a conventional cell using the same form factor.

In one or more embodiments, a lithium ion secondary cell has a long run time (high energy) while providing short-duration, high-rate pulses with low voltage drop (low polarization, <100 mV under standard GSM pulsing at 2 A peak), and is suitable for short duration pulse applications, including but not limited to wireless communications and medical devices.

Lithium secondary cells are also provided having stacked energy densities exceeding 200 Wh/Kg and exceeding 600 Wh/L. In a prismatic form factor such as 63450 (where ‘6’ indicates a thickness of about 6 mm, ‘34’ indicates a width of 34 mm, and ‘50’ indicates a height of 50 mm), cell energy densities exceeding 200 Wh/Kg and 500 Wh/L are provided. Such cells have pulse capabilities exceeding the requirements of GSM, CDMA, IDEN, while being safer in external and internal shorting and thermal runaway (hotbox) tests than previous cells of comparable energy density.

### BRIEF DESCRIPTION OF THE DRAWING

A more complete appreciation of the present invention and many of its advantages will be understood by reference to the following detailed description when considered in connection with the following drawings, which are presented for the purpose of illustration only and are not intended to limit the scope of the appended claims, and in which:

FIG. 1 is a schematic illustration of a lithium ion secondary cell having a stacked cell construction;

FIG. 2 is a schematic illustration of a wireless communication device incorporating a lithium ion secondary cell according to one or more embodiments of the invention;

FIG. 3 shows the voltage vs. time plot for a cell prepared as in Example 1 with a cell capacity of 1.4 Ah that was cycled according to the following sequence: (a) charge at C/10 (0.14 A), (b) discharge at C/10 (0.14 A), (c) charge at C/5 (0.28 A), and discharge at GSM protocol (2 A, 550 μsec pulse every 4.6 ms, 100 mA pulse-off current for the remaining 4.05 ms of the cycle);

FIG. 4 shows the capacity of the cell of FIG. 3 vs. charge/discharge cycle number;

FIG. 5 shows the voltage vs. time plot for a cell of similar cell design to that of Example 1 with a higher cell capacity of 1.5 Ah that was cycled according to the following sequence: (a) charge at C/10 (0.15 A), (b) discharge at C/10 (0.15 A), (c) charge at C/5 (0.3 A), and discharge at GSM protocol (2 A, 550 μsec pulse every 4.6 ms, 100 mA pulse-off current for the remaining 4.05 ms of the cycle);

FIG. 6 shows the capacity of the cell of FIG. 5 vs. charge/discharge cycle number; and

FIG. 7 shows a voltage vs. time plot for the GSM pulse discharge of a commercial 63450 cell.

### DETAILED DESCRIPTION

Cells for batteries that are useful for pulsed-current applications are those that are capable of delivering the high pulse current without excessive polarization voltage drop (since otherwise the lower voltage cutoff of the device may be met during the pulse, leading to device shut-down which effectively reduces the practical capacity of the cell despite it being in a relatively well-charged state). Further, pulse-mode run time is maximized for a cell with a high capacity that can deliver the pulse currents with low voltage drop. It is not important that the cell has a high rate capability under continuous draw discharge as pulsed-current devices do not draw high continuous currents. The maximum continuous current would be that drawn by the continuous transmission of data using the CDMA protocol when farthest from a communications tower, and would be 700-800 mA. So for longest run times, cells specifically designed to have high energy density at the expense of high discharge rate-capability and that are able to deliver relatively low continuous current draw and high pulse current with low polarization are especially suitable. Under high rate pulse discharge (at short time scales), the polarization is dominated by the voltage drop across the separator and, thus, separator impedance is a factor affecting performance. The use of a high rate separator reduces the voltage drop across the separator.

In one or more embodiments, the lithium secondary cell includes a low rate, high energy density positive electrode, a high rate separator (including highly conductive electrolyte) and a high energy density negative electrode. Thus, the cells according to one or more embodiments of the present invention have very high energy density, deliver 750 mA with >96% capacity retention and show very low polarization even on the 2 A pulse of the GSM protocol. Such cells are therefore suited to telecommunications applications. In one or more embodiments, the cells are operated according to a pulse protocol selected from one of the following: GSM, CDMA, and IDEN.

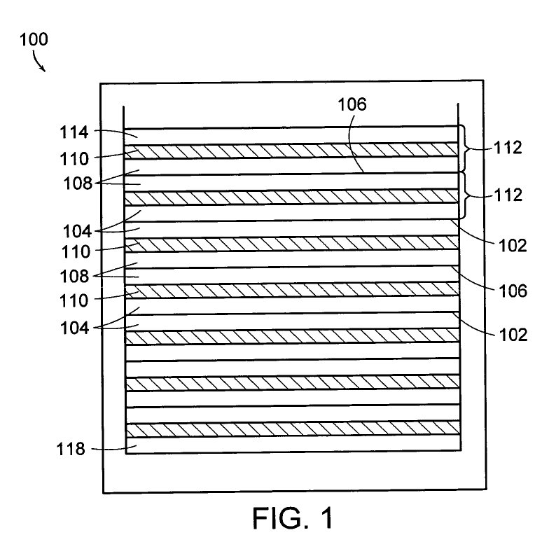

FIG. 1 is an illustration of a typical stacked cell construction 100. The stacked cell construction includes a positive current collector 102 coated on two sides with positive cathode 104 and a negative current collector 106 coated on two sides with negative anode 108. Interposed between each double-sided electrode is a separator 110. The repeated arrangement of positive electrode/separator/negative electrode forms multiple individual cells 112 bounded by a positive current collector and a negative current collector. Single-sided cathodes 114, 118 on the outer two faces of the stacked assembly complete the stacked cell construction. The single-sided cathodes are bounded by a positive or negative current collector as appropriate for the cathode. These current collectors at the outer faces of the stacked assembly are coated on one side as shown in FIG. 1. The entire stacked assembly is infused with electrolyte (not shown). The use of stacked layers permits use of thicker electrodes to obtain higher energy capacity without the limits due to radius of curvature found in wound cells. In a typical stacked cell, 22 individual stacked cells 112 are included in a single battery. In some embodiments, about 2-30 individual stacked cells 112 are included in a single battery. In other embodiments, about 5-25 individual stacked cells 112 are included in a single battery. In further embodiments, about 15-25 individual stacked cells 112 are included in a single battery. In some embodiments, about 18 individual stacked cells 112 are included in a single battery. In other embodiments, about 20 individual stacked cells 112 are included in a single battery. In further embodiments, about 24 individual stacked cells 112 are included in a single battery.

The positive electrode includes a cathode active material, a conductive additive and a binder. The cathode active material can be chosen from a number of candidates (subject to the restrictions outlined herein), including but not limited to lithium cobalt oxide, lithium nickel cobalt oxide, lithium nickel manganese cobalt oxide, lithium manganese oxide, or mixtures of two or more of these materials.

Similarly, the negative electrode includes an anode active material, a conductive additive and a binder. The anode active material can chosen from a number of candidates (subject to the restrictions outlined herein), including but not limited to synthetic graphite, natural graphite, mesocarbon microbeads (MCMB), coke, metal and metal alloy anode materials (e.g. Sn), metalloid anode materials (e.g. Si), and intermetallic compound anode materials.

The conductive additive includes, for example, acetylene black, carbon black and graphite.

The binder can perform the functions of allowing the current collector to hold the active material and of joining the active material particles. Exemplary materials used as the binder include, for example, polytetrafluoro ethylene (PTFE), polyvinylidene fluoride (PVdF), an ethylene-propylene-diene copolymer (EPDM), and styrene-butadiene rubber (SBR).

Exemplary positive electrode compositions include between about 92 and about 99% by weight of cathode active material, a range of about 0.5% and about 4% by weight of conductive diluent, and a range of between about 0.5% and about 4% by weight binder. The positive electrode is deposited on both sides of a current collector at a total thickness of greater than about 200 μm. In some embodiments, the positive electrode has a total thickness of greater than about 230 μm. In some embodiments, the positive electrode has a total thickness of greater than about 250 μm. In other embodiments, the positive electrode has a total thickness of about 200 μm to about 250 μm. The current collector is a thin metal foil, typically aluminum or some other conductive material stable at the maximum positive electrode potential.

In some embodiments, the positive electrode has a total volumetric energy density of at least about 1460 Wh/L versus lithium at C/5 rate. In other embodiments, the positive electrode has a total volumetric energy density of at least about 1480 Wh/L versus lithium at C/5 rate. In further embodiments, the positive electrode has a total volumetric energy density of at least about 1500 Wh/L versus lithium at C/5 rate. In yet other embodiments, the positive electrode has a total volumetric energy density of at least about 1520 Wh/L versus lithium at C/5 rate. In other embodiments, the positive electrode has a total volumetric energy density of at least about 1540 Wh/L versus lithium at C/5 rate. In some embodiments, the positive electrode has a total volumetric energy density of at least about 1460 Wh/L to about 1540 Wh/L versus lithium at C/5 rate.

In some embodiments, the positive electrode has a total areal capacity of greater than about 7.5 mA-h/cm². In some embodiments, the positive electrode has a total areal capacity of greater than about 7.7 mA-h/cm². In other embodiments, the positive electrode has a total areal capacity of greater than about 8.0 mA-h/cm². In further embodiments, the positive electrode has a total areal capacity of greater than about 9.0 mA-h/cm². In yet more embodiments, the positive electrode has a total areal capacity of about 7.5 mA-h/cm² to about 10.0 mA-h/cm².

Exemplary negative electrode compositions include between about 92 and about 99% by weight of anode active material, a range of about 0% and about 3% by weight of conductive diluent, and a range of between about 1% and about 5% by weight binder. The negative electrode is deposited on both sides of a current collector, unless the electrode is located at the end of the stacked cell, in which case only one side is coated. The total thickness of the negative electrode will vary depending on the nature of the negative electrode active material, e.g., carbonaceous or metallic, but it is at a load level that provides an energy capacity matching or exceeding the capacity of the positive electrode.

In some embodiments, the negative electrode has a total volumetric specific capacity including current collector foil of at least about 460 Ah/L. In some embodiments, the negative electrode has a total volumetric specific capacity including current collector foil of at least about 483 Ah/L. In other embodiments, the negative electrode has a total volumetric specific capacity including current collector foil of at least about 510 Ah/L. In other embodiments, the negative electrode has a total volumetric specific capacity including current collector foil of at least about 555 Ah/L. In further embodiments, the negative electrode has a total volumetric specific capacity including current collector foil of at least about 460 Ah/L to about 555 Ah/L. In some embodiments, the negative electrode has a total volumetric specific capacity including current collector foil of at least about 460 Ah/L to about 510 Ah/L. In further embodiments, the negative electrode has a total volumetric specific capacity including current collector foil of at least about 460 Ah/L to about 483 Ah/L.

A cell made from a lithium cobalt oxide positive electrode and a graphite negative electrode meeting the above criteria can by made using the following range of compositions:

Positive electrode: 92-99 w % LCO; 0.5-4 w % acetylene black; and 0.5-4 w % PVdF binder at a thickness of greater than 200 μm.

Negative electrode: 94-99 w % graphite; 0-3 w % acetylene black; and 1-3 w % SBR latex-carboxymethylcellulose (CMC) blend, in ratios of SBR:CMC of 1:4 to 100% SBR latex, or 2-6 w % PVdF-based binder at a thickness of greater than 150 μm.

The separator is formed essentially of a porous sheet. The porous sheet used as the separator includes, for example, a porous film and a nonwoven fabric. It is desirable for the porous sheet to contain at least one material selected from the group consisting of polyolefin and cellulose. The polyolefin noted above includes, for example, polyethylene and polypropylene. Particularly, it is desirable to use a porous film containing polyethylene, polypropylene or both polyethylene and polypropylene as the separator because the particular separator permits improving the safety of the secondary battery.

In one or more embodiments, the thickness of the porous sheet is less than about 50 μm, or in the range of about 10 μm to about 30 μm. The separator has a porosity of greater than about 45%, or greater than about 50%.

A stacked assembly is made by alternately stacking positive and negative electrode layers meeting the above criteria with high porosity separator layers that electrically isolate the electrode layers, either manually or by employing an automated stacking machine. The stacked cell construction is activated with one of a family of liquid electrolytes suitable for Li-ion cells. The electrolyte may be infused into a porous separator that spaces apart the positive and negative electrodes.

Numerous organic solvents have been proposed as Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include γ-BL, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate and the like. These nonaqueous solvents are typically used as multicomponent mixtures.

As the lithium salt, at least one compound from among LiClO₄, LiPF₆, LiBF₄, LiSO₃CF₃, LiN(SO₂CF₃)₂ , LiN(SO₂CF₂CF₃)₂ and the like are used. The lithium salt is concentration from 0.5 to 1.5 M, or about 1.3 M. In one or more embodiments, the lithium salt is used at a concentration of greater than 1.0 M. Typically the electrolyte is a solution of mixed carbonate solvents with a Li salt (e.g., LiPF₆) dissolved as the charge carrying species.

Under short duration, high current pulses, the electrolyte has a tendency to polarize. Therefore, it is desirable to maximize the ionic conductivity of the electrolyte. Typically, the conductivity of an electrolyte increases with increasing salt concentration to a maximum conductivity, after which the conductivity of the solution decreases. The decrease in conductivity even with increasing salt concentration is attributed to the increase in solution viscosity, which reduces the diffusion mobility of the ions, increases polarization and thereby effectively reduces conductivity. Under the short pulse times used in pulsed protocols, however, there is insufficient time for polarization to occur. Thus, it is possible and even desirable to use electrolytes with very high salt concentrations. In one or more embodiments, the salt concentration is above the salt concentration used for optimal conductivity under constant charge conditions. For example, the lithium salt is greater than 0.5 M, or even greater than 1.3 M. In some embodiments, the lithium salt concentration is about 0.5 M to about 1.5 M. The conductivity of the electrolyte is about 5-15×10⁻³ S.

Further, although the above description uses an example of a liquid type nonaqueous electrolyte Li-ion battery, it is to be understood that other types of non-aqueous electrolytes, such as those of gel or solid polymer type can be used to manufacture thin batteries of this invention. The electrolyte may be an inorganic solid electrolyte, e.g., L₃iN or LiI, or a high molecular weight solid electrolyte, such as a gel, provided that the material exhibits lithium conductivity. Exemplary high molecular weight compounds include poly(ethylene oxide), poly(methacrylate) ester based compounds, or an acrylate-based polymer, and the like. In other embodiments, electrodes may be bonded to their respective separators and packaged in thin metal-polymer laminate film bags as an outer casing material.

A high energy lithium ion secondary cell operating at a minimum of 1.25 Ah includes a high energy density positive electrode with a total electrode volumetric energy density of at least about 1290 Wh/L as measured versus a graphite anode or of at least about 1460 Wh/L as measured versus Li metal. This is determined by dividing the discharge energy at C/5, taken as the integration of the discharge voltage over the range of discharge capacity in an electrochemical cell vs. an anode (e.g. Li metal), by the total positive electrode volume (area multiplied by thickness of electrode coated on 2 sides, plus the foil thickness.) This corresponds to electrode active loadings of at least about 59 mg/cm² for a two sided electrode in a system having a total electrode plus current collector foil thickness of about 230 μm. The cell also includes a high energy density negative electrode with a volumetric specific capacity including current collector foil of at least about 460 Ah/L (545 Ah/L in the embodiment of Example 1). This corresponds to electrode active loadings of at least about 23 mg/cm² (per side of a doubly coated current collector) in a graphite system having a total electrode plus current collector foil thickness of about 184 μm. The porous separator material is about 10-30 μm thick and has a porosity greater than about 45 vol %. The combined cathode/separator/anode stacked electrochemical system thus obtained should have a minimum stack energy density of 600 Wh/L.

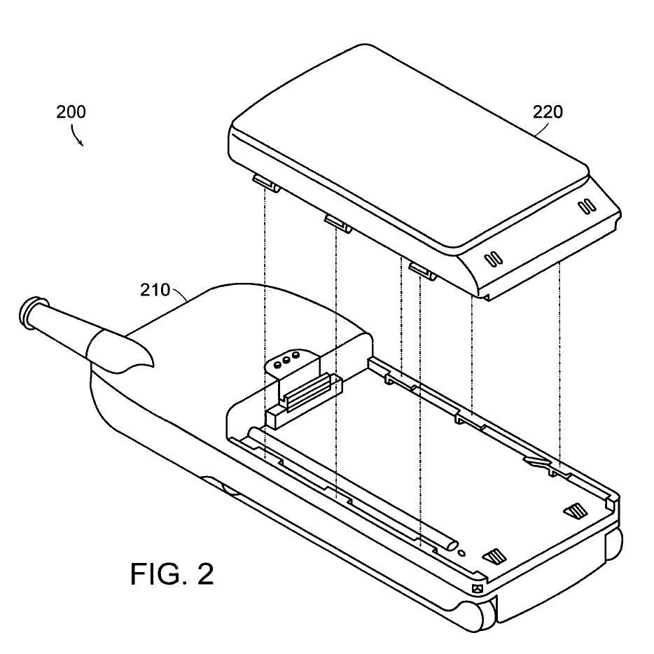

The lithium ion secondary cell according to one or more embodiments of the present invention may be incorporated into wireless communication devices that are operatable using a variety of pulsed protocols. As illustrated in FIG. 2, the invention includes a wireless communication device 200 for electronic communication. FIG. 2 illustrates a cellular phone 210, including a battery pack 220. The battery pack includes the stacked lithium ion secondary cell (not shown) according to one or more embodiments of the present invention. The battery delivers a current pulse at regular intervals to the device. The pulse may be of fixed frequency and amplitude, or the frequency and/or the amplitude may vary under use conditions.

The device may be operated by delivery of current pulses at standard wireless communication pulse protocols. The battery provides a 40% longer run time over conventional batteries of the same form factor. In some embodiments, the battery delivers a pulsed current of about 0.5-1.5 ms in duration. In some embodiments, the battery delivers a pulsed current of about 550 μsec. In other embodiments, the battery delivers a pulsed current of about 495 μsec. In further embodiments, the battery delivers a pulsed current of about 605 μsec. In further embodiments, the battery delivers a pulsed current of about 495 μsec to about 605 μsec.

In some embodiments, the battery delivers a pulsed current of at least about 700 mA. In other embodiments, the battery delivers a pulsed current of at least about 1 A. In further embodiments, the battery delivers a pulsed current of at least about 1.2 A. In some embodiments, the battery delivers a pulsed current of up to about 2 A. In further embodiments, the battery delivers a pulsed current of about 700 mA to about 2 A.

In some embodiments, the battery delivers a pulsed current of at least about 700 mA for a duration of at least about 550 μsec with polarization of less than about 100 mV. In other embodiments, the battery delivers a pulsed current of up to about 2 A for a duration of at least about 550 μsec with polarization of less than about 100 mV.

In some embodiments, the battery delivers an off-pulse of about 50 mA to about 250 mA. In some embodiments, the battery delivers an off-pulse of about 100 mA to about 200 mA. In some embodiments, the battery delivers an off-pulse of about 100 mA. In some embodiments, the battery delivers an off-pulse of about 150 mA. In further embodiments, the battery delivers an off-pulse of about 200 mA. In yet other embodiments, the battery delivers an off-pulse of about 250 mA.

Some wireless communication devices have both a transmitter and receiver. Other wireless communication devices, known in the art as “transponders,” are interrogated by interrogation reader, whereby the transponder communicates back by altering a field containing an interrogation signal. It should be readily understood to one of ordinary skill in the art that there are many other different types of wireless communication devices that allow electronic communication and are operated using a pulsed current protocol, and thus the present invention is not limited to any one particular type. In one embodiment, the device is a cellular telephone. In another embodiment, the device is a two-way pager. In one or more embodiments, the communication device is operated according to a pulse protocol selected from one of the following: GSM, CDMA, and IDEN.

The invention is illustrated in the following examples, which are presented for the purpose of illustration only and are not intended to be limiting of the invention.

### EXAMPLE 1

### A Lithium-Ion Cell is Described

An aqueous anode slurry was prepared by mixing the following ingredients in a double planetary mixer: synthetic graphite (D50=15 micron), acetylene black (specific surface area=65 m²/g), lithium ion battery grade SBR latex binder and carboxymethyl cellulose. All ingredients were in the dry ratio of 95.35:2.15:1.25:1.25 parts, and the final slurry had 50 wt % solids in water. Oxalic acid was added to the slurry at 0.5% (w/w dry). This paste was coated onto both sides of a 10 micron thick copper foil, hot air force-dried, then calendared to a final total thickness of 180 microns with a total loading of 28.8 mg/cm².

A cathode slurry was prepared by mixing the following ingredients in a double planetary mixer: LCO (D50=10 micron), acetylene black (specific surface area 65 m²/g), PVDF binder and N-methyl pyrrolidinone. All ingredients were in the dry ratio of 95:2.5:2.5 and the final slurry had 70 wt % solids in N-methyl pyrrolidinone. This paste was coated onto both sides of a 15 micron aluminum foil, hot air force-dried, then calendared to a final thickness of 230 microns with a total loading of 73.8 mg/cm².

Single-sided cathodes were also prepared by coating only one side of the aluminum foil to yield an electrode that had the same physical characteristics as the coating on each side of the double-sided cathode coating. The total electrode volumetric energy density was 1540 Wh/L as measured versus a graphite anode or 1740 Wh/L as measured versus Li metal.

The individual anodes and cathodes were punched from these coatings using a pneumatic punch, and dried overnight at 130° C. under vacuum in a dry room. In the dry room the electrodes were stacked alternately (with single sided-cathodes on the outer two faces of the final stack), and co-wound with a 20 micron polyethylene separator having porosity 52% using an automated stacker-winder.

The individual anode and cathode tabs were ultrasonically welded together to form single anode and cathode tabs, which were then welded to the cap of an aluminum 63450 prismatic can using a resistance welder. The stack and affixed header were fed into the aluminum can, and the anode tab was taped with electrochemically stable Kapton™ tape to prevent electrical shorting to the can. The cap was welded to the can using a YAG laser. The cell was activated with a commercially available liquid electrolyte based on LiPF₆ in mixed carbonate solvents, with VC (vinylene carbonate) and PS (propane sultone) added for long cycle life and low gassing. The cell was formed at a current of C/10 then the fill port was sealed with an aluminum ball bearing, which was either covered with epoxy, or laser welded to form a hermetic seal.

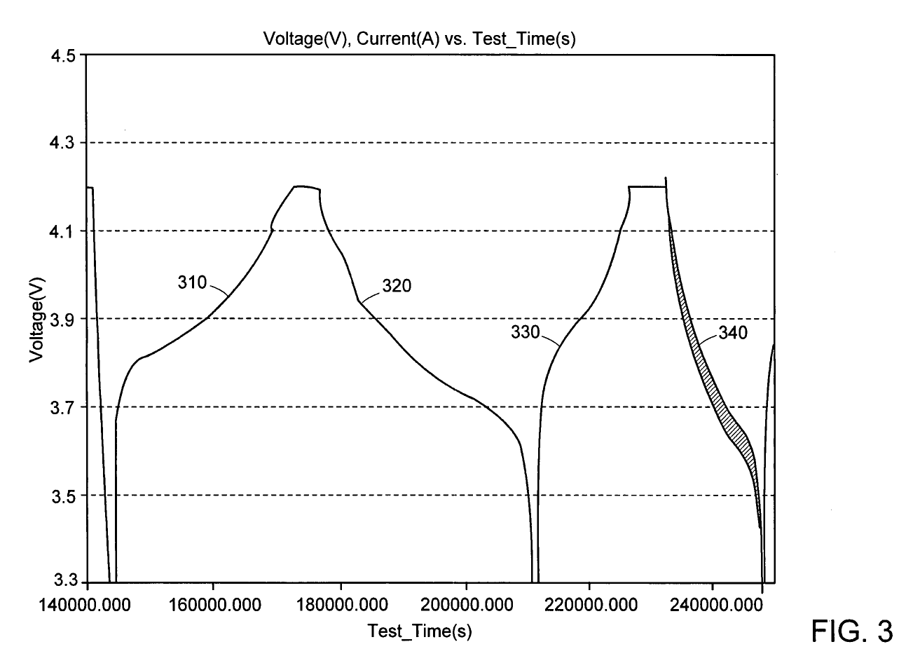

The cell was then charged and cell performance under GSM protocol was evaluated. FIG. 3 shows the voltage vs. time plot for a cell cycled according to the following sequence. Curve 310 shows cell charging at C/10 (0.14 A); curve 320 shows cell discharging at C/10 (0.14 A); and curve 330 shows cell charging at C/5 (0.28 A). Once fully charged at C/5 rate, the cell was discharged under GSM protocol (2 A, 550 μsec pulse every 4.6 ms, 100 mA pulse-off current for the remaining 4.05 ms of the cycle), as illustrated by curve 340. The thick line during GSM pulse discharge is due to the voltage change before and in the middle of the 2 A pulse and illustrates an approximately 50 mV polarization of the cell during pulsing. The duration of the pulse discharge, e.g., cell run time, was about 4.15 hours.

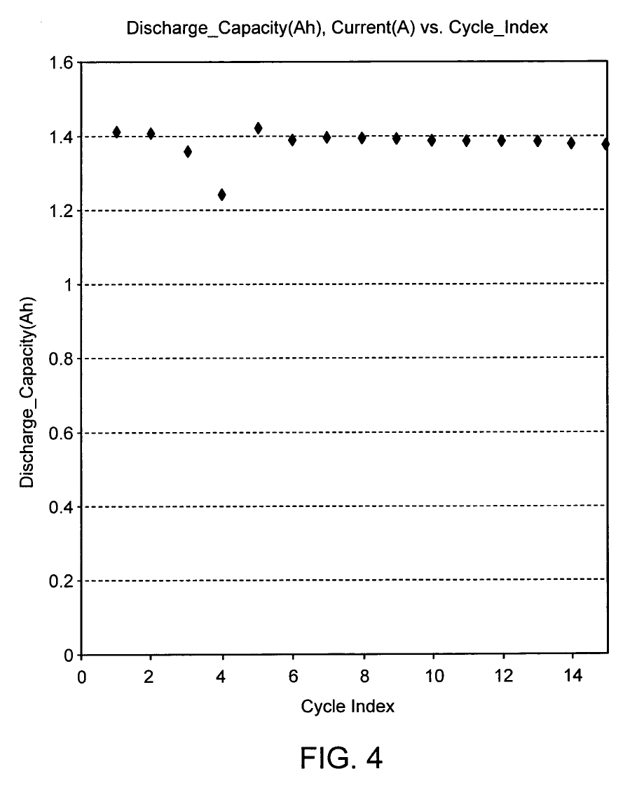

FIG. 4 shows the capacity of the cell of FIG. 1 vs. charge/discharge cycle number. The currents used to discharge the cell were (in order of cycle number) C/10, C/5, C/2, 1C, C/10, C/10 and then all C/3 to the final cycle. This illustrates that the cell has 1.4 Ah capacity with constant capacity on cycling.

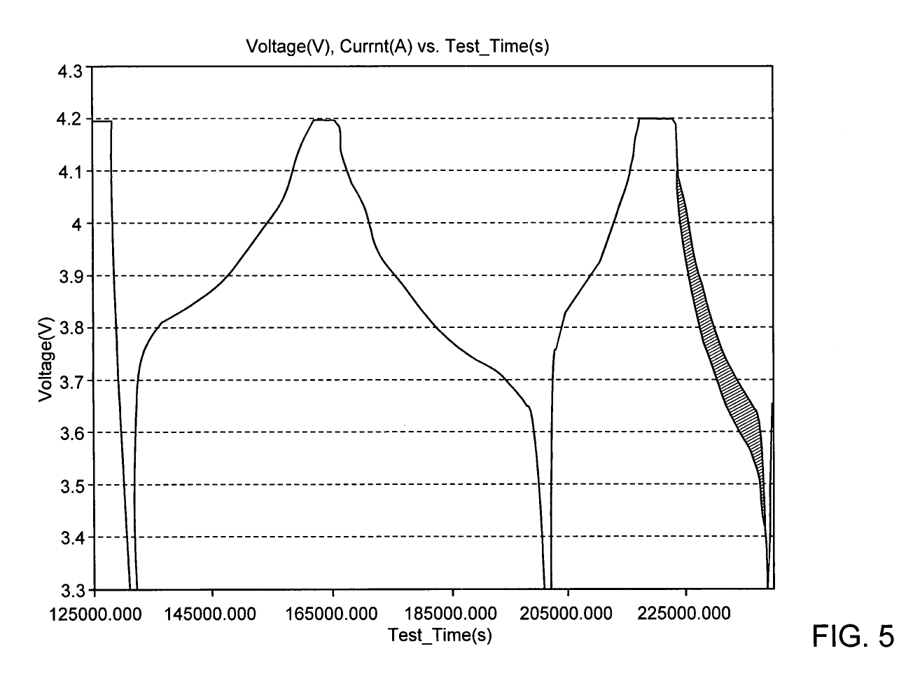

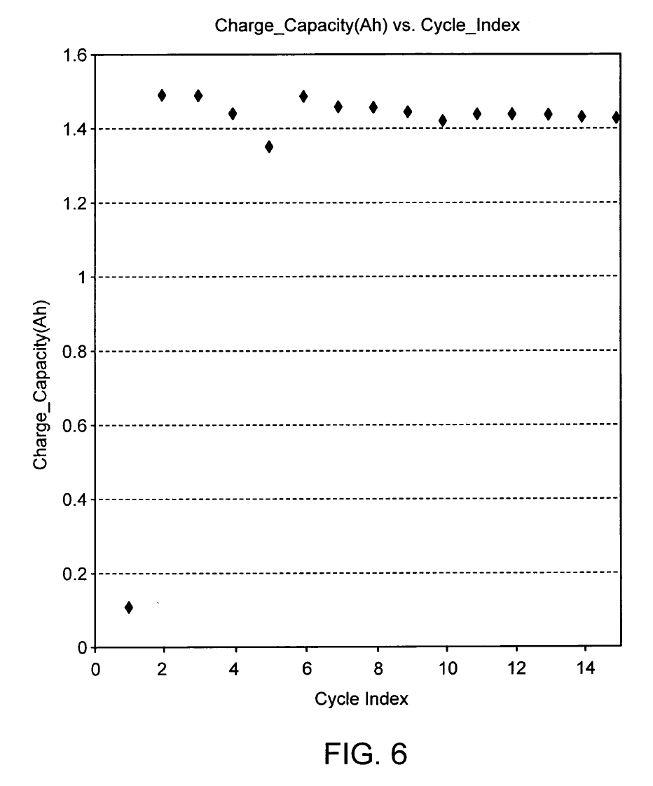

Cells of 1.5 Ah capacity have also been prepared with correspondingly higher volumetric energy densities. See, FIGS. 5 and 6. FIG. 5 shows the voltage vs. time plot for the cell which was cycled according to the following sequence: (a) charge at C/10 (0.15 A), (b) discharge at C/10 (0.15 A), (c) charge at C/5 (0.3 A), and discharge at GSM protocol (2 A, 550 μsec pulse every 4.6 ms, 100 mA pulse-off current for the remaining 4.05 ms of the cycle. The cell demonstrated a polarization of about 90 mV during GSM pulse discharge and had a run time of about 4.28 hours. FIG. 6 shows the capacity of the cell of FIG. 5 vs. charge/discharge cycle number. This cell had a capacity of 1.5 Ah (with volumetric energy densities of 726 Wh/l for the stack and 550 Wh/l for the full cell) and >70% capacity retention (i.e. >1 Ah) after 300 cycles. The impedance of this cell is 25 mohm.

### EXAMPLE 2

### Comparative 63450 Cell Under Same Test Conditions, Demonstrating Lower Run Time

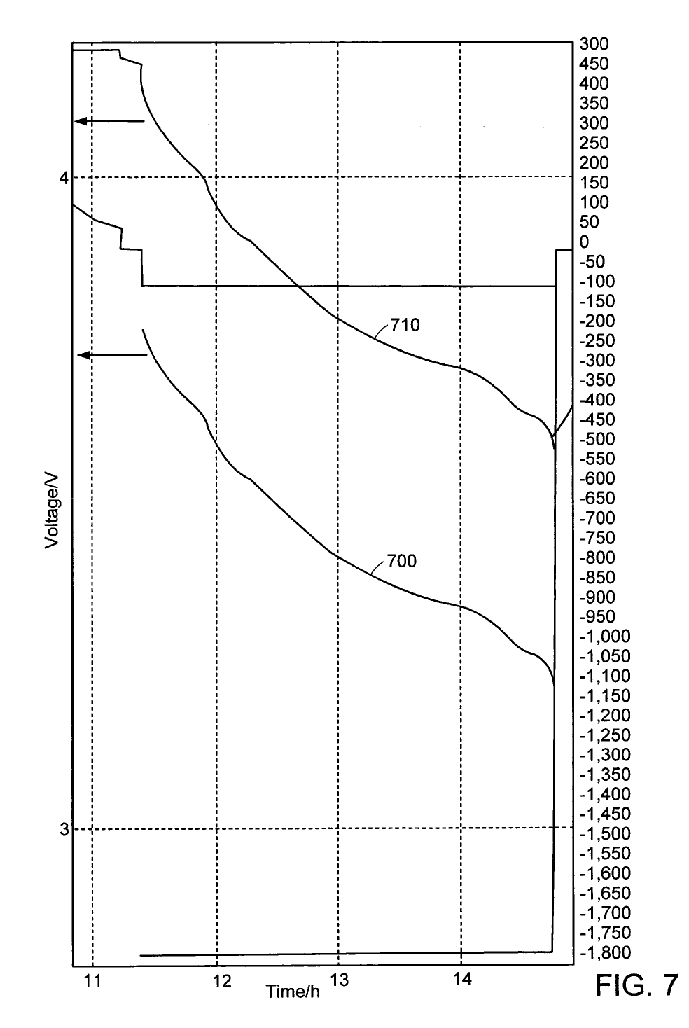

The performance of the cell of Example 1 was compared to that of a commercially available prismatic cell of 63450 form factor. The comparative 63450 cell was discharged by a GSM protocol with a 1.8 A pulse, that is, a pulse current less than that of Example 1. FIG. 7 shows a voltage vs. time plot for the GSM pulse discharge of a commercial 63450 cell and demonstrates the cell discharges to the 3.2V cutoff voltage after 3.5 hours. This is compared to the run times of 4.15 and 4.28 hours for the cells of Example 1. FIG. 7 shows two curves 700 and 710, recording the voltage during the pulse and during the “pulse-off” 100 mA discharge, respectively. This difference in the voltage before and during the pulse for the cell represents cell polarization and is quite large (about 350 mV) compared to the cells of Example 1. The cell capacity was rated at 1 Ah, but measured to be 1.1 Ah.

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. Accordingly, those skilled in the art would recognize that the use of an electrochemical device in the examples should not be limited as such. The present invention is directed to each individual feature, system, or method described herein. In addition, any combination of two or more such features, systems or methods, if such features, systems or methods are not mutually inconsistent, is included within the scope of the present invention.

What is claimed is:

1. A lithium secondary cell, comprising:
a plurality of stacked layers, said stacked layer comprising:
a lithium-containing positive electrode in electronic contact with a positive electrode current collector, the positive current collector in electrical connection with an external circuit, wherein the positive electrode has a total volumetric energy density of at least about 1460 Wh/L versus lithium at C/5 rate;
a negative electrode in electronic contact with a negative electrode current collector, the negative current collector in electrical connection with an external circuit;
a separator positioned between the positive electrode and the negative electrode, the separator having a porosity of at least about 45 vol % and a thickness of less than about 50 μm; and
an electrolyte in ionic contact with the positive and negative electrodes, wherein the cell is capable of providing a pulsed current of at least about 700 mA for a duration of at least about 550 μsec with polarization of less than about 100 mV.

2. The lithium secondary cell of claim 1, wherein the positive electrode has a total areal capacity of greater than about 7.5 mA-h/cm² and a total thickness of at least about 200 μm.

3. The lithium secondary cell of claim 2, wherein the positive electrode has a total areal capacity of greater than about 7.5 mA-h/cm² and a total thickness of at least about 230 μm.

4. The lithium secondary cell of claim 2, wherein the positive electrode has a total areal capacity of greater than about 8.0 mA-h/cm².

5. The lithium secondary cell of claim 2, wherein the positive electrode has a total areal capacity of greater than about 9.0 mA-h/cm².

6. The lithium secondary cell of claim 1, wherein the electrolyte has a conductivity of about 5-15×10⁻³ S, and an electrolyte salt concentration in the range of about 0.5 M to 1.5 M.

7. The lithium secondary cell of claim 6, wherein the electrolyte has a salt concentration of greater than about 1.3 M.

8. The lithium secondary cell of claim 1, wherein the separator has a thickness in the range of about 10 μm to about 30 μm.

9. The lithium secondary cell of claim 1, wherein the positive electrode comprises an active material selected from the group consisting of lithium cobalt oxide, lithium nickel cobalt oxide, lithium nickel manganese cobalt oxide, lithium manganese oxide, and mixtures thereof.

10. The lithium secondary cell of claim 1, wherein the positive electrode comprises lithium cobalt oxide.

11. The lithium secondary cell of claim 1, wherein the negative electrode comprises an active material selected from the group consisting of synthetic graphite, natural graphite, mesocarbon microbeads (MCMB), coke, metal and metal alloy anode materials, metalloid anode materials, and intermetallic compound anode materials.

12. The lithium secondary cell of claim 1, wherein the negative electrode has a total volumetric energy density equal to or exceeding that of the positive electrode.

13. The lithium secondary cell of claim 1, wherein the cell comprises 22 stacks.

14. The lithium secondary cell of claim 1, wherein the cell has a discharge life of greater than about 4 hours under GSM pulse testing protocol with a pulse current equal to about 2 A.

15. A lithium secondary cell, comprising:
a plurality of stacked layers, said stacked layer comprising:
a lithium-containing positive electrode in electronic contact with a positive electrode current collector, the positive current collector in electrical connection with an external circuit, wherein the positive electrode has a total volumetric energy density of at least about 1460 Wh/L versus lithium at C/S rate and wherein the total thickness of the positive electrode is greater than about 200 micron;
a negative electrode in electronic contact with a negative electrode current collector, the negative current collector in electrical connection with an external circuit, wherein the negative electrode has a total volumetric specific capacity including current collector foil of at least about 460 Ah/L;
a separator positioned between the positive electrode and the negative electrode, the separator having a porosity of at least about 45 vol % and a thickness of less than about 50 μm; and
an electrolyte in ionic contact with the positive and negative electrodes, wherein the cell has a stacked energy density of at least about 600 Wh/L at C/5.

16. A portable electronic device operable according to a pulsed current protocol, comprising:
a wireless communication device; and
a lithium secondary battery according to claim 1 for providing power to the wireless device, wherein power is delivered as pulsed current.

17. The portable electronic device of claim 16, wherein the lithium secondary battery comprises:
a lithium-containing positive electrode in electronic contact with a positive electrode current collector, the positive current collector in electrical connection with an external circuit, wherein the positive electrode has a total areal capacity of greater than about 7.5 mA-h/cm² and a total thickness of at least about 200 μm.

18. The portable electronic device of claim 16, wherein the positive electrode has a total areal capacity of greater than about 8.0 mA-h/cm².

19. The portable electronic device of claim 16, wherein the positive electrode has a total areal capacity of greater than about 9.0 mA-h/cm².

20. The portable electronic device of claim 16, wherein the electrolyte has a conductivity of about 0.5-1.5×10⁻³ S, and an electrolyte salt concentration in the range of about 0.5 M to 1.5 M.

21. The portable electronic device of claim 16, wherein the battery delivers a pulsed current of about 0.5-1.5 ms in duration.

22. The portable electronic device of claim 16, wherein the battery delivers a pulsed current of at least about 700 mA for a duration of at least about 550 μsec with polarization of less than about 100 mV.

23. The portable electronic device of claim 16, wherein the battery delivers a pulsed current of up to 2 A for a duration of at least about 550 μsec with polarization of less than about 100 mV.

24. The portable electronic device of claim 16, wherein the battery delivers an off-pulse of about 100 mA.

25. The portable electronic device of claim 16, wherein the portable electronic device is a two-way pager.

26. The portable electronic device of claim 16, wherein the portable electronic device is a cellular phone.

27. The portable electronic device of claim 16, wherein the device is operated according to a pulse protocol selected from the group consisting of GSM, CDMA and IDEN.

28. A method of operating a lithium secondary battery, comprising:
providing a lithium secondary battery according to claim 1; and delivering a current pulse of at least about 700 mA for a duration of at least about 500 μsec with polarization of less than about 100 mV from the battery through the external circuit.

29. The method of claim 28, wherein the cell delivers a pulsed current of about 0.5-1.5 ms in duration.

30. The method of claim 28, wherein the lithium secondary battery comprises:
a lithium-containing positive electrode in electronic contact with a positive electrode current collector, the positive current collector in electrical connection with an external circuit, wherein the positive electrode has a total areal capacity of greater than about 7.5 mA-h/cm² and a total thickness of at least about 200 μm.

31. The method of claim 28, wherein the positive electrode has a total areal capacity of greater than about 8.0 mA-h/cm².

32. The method of claim 28, wherein the positive electrode has a total areal capacity of greater than about 9.0 mA-h/cm².

33. The method of claim 28, wherein the electrolyte has a conductivity of about 5-15×10⁻³ S, and an electrolyte salt concentration in the range of about 0.5 M to 1.5 M.

34. The method of claim 28, wherein the battery delivers an off-pulse current of about 100 mA.
